(19) United States
(12) Patent Application Publication
(10) Pub. No.: US 2015/0227552 A1
(43) Pub. Date: Aug. 13, 2015

(54) MANAGEMENT METHOD, MANAGEMENT DEVICE, AND MANAGEMENT SYSTEM

(71) Applicants: FUJITSU LIMITED, Kawasaki-shi (JP); HONDA MOTOR CO., LTD., Tokyo (JP)

(72) Inventors: Naoki Hashiguchi, Yokohama (JP); Masayuki Okishio, Utsunomiya (JP); Yasuo Kurosaki, Wako (JP); Hiroshi Ishida, Wako (JP)

(73) Assignees: FUJITSU LIMITED, Kawasaki-shi (JP); HONDA MOTOR CO., LTD., Tokyo (JP)

(21) Appl. No.: 14/595,393

(22) Filed: Jan. 13, 2015

(30) Foreign Application Priority Data
Feb. 7, 2014 (JP) 2014-022730

(51) Int. Cl. G06F 17/30

(52) U.S. Cl. CPC G06F 17/30221

(57) ABSTRACT

A non-transitory computer-readable recording medium stores a data management program that causes a computer to execute a process. The computer is configured to store data, which is a development deliverable of a product, in one of folders included in a storage folder group having a hierarchal structure. The process includes referring to a storage unit storing a plurality of items constituting an ISO (International Organization for Standardization) specification defining a development process of the product; outputting one or more items as options among the plurality of items constituting the ISO specification defining the development process of the product, when applying an attribute to the one of the folders included in the storage folder group; and implementing control to store the attribute corresponding to a selected item among the one or more items that have been output in association with the one of the folders.

### CROSS-REFERENCE TO RELATED APPLICATION

This patent application is based upon and claims the benefit of priority of the prior Japanese Patent Application No. 2014-022730 filed on Feb. 7, 2014, the entire contents of which are incorporated herein by reference.

### FIELD

The embodiments discussed herein are related to a management method, a management device, and a management system.

### BACKGROUND

ISO6262 is a function safety standard for the automobile industry, which is an example of an ISO (International Organization for Standardization) specification. ISO26262 is constituted by ten parts of Part 1 through Part 10. Each part is further constituted by items segmentalized in steps.

Meanwhile, in a data management system for managing data of a deliverable such as a document created in a development process of a product, there is a system in which a folder that is the storage destination of the deliverable, may be defined in advance. For example, the storage destinations of the deliverables that are assumed to be created in the respective stages of the development process, are defined in advance by a system administrator.

The person in charge of development creates a deliverable corresponding to a storage destination defined in advance as the development process proceeds, and stores the deliverable in the storage destination. By repeating such an operation at the respective stages in the development process, it is possible to manage the deliverables, such that it is easily recognized that the deliverables needed for development are created without any omission.

Patent Document 1: Japanese Laid-Open Patent Publication No. H10-254745

Patent Document 2: Japanese Laid-Open Patent Publication No. 2001-51983

In the above data management system, the storage destination of the deliverable is defined in association with the configuration of ISO26262, and by making it possible to set the association relationship between each storage destination and an element of ISO26262, it is easily indicated that the operation procedure is in compliance with ISO26262.

However, it is troublesome for the system administrator to perform the operation of identifying the items constituting ISO26262 by referring to a paper document relevant to the specification, and associating the items with storage destinations.

### SUMMARY

According to an aspect of the embodiments, a non-transitory computer-readable recording medium stores a data management program that causes a computer to execute a process, the computer being configured to store data, which is a development deliverable of a product, in one of folders included in a storage folder group having a hierarchal structure, the process including referring to a storage unit storing a plurality of items constituting an ISO (International Organization for Standardization) specification defining a development process of the product; outputting one or more items as options among the plurality of items constituting the ISO specification defining the development process of the product, when applying an attribute to the one of the folders included in the storage folder group; and implementing control to store the attribute corresponding to a selected item among the one or more items that have been output in association with the one of the folders.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a configuration example of a data management system according to an embodiment of the present invention;

FIG. 2 illustrates an example of a hardware configuration of the data management server according to an embodiment of the present invention;

FIG. 3 illustrates an example of a functional configuration of the data management system according to an embodiment of the present invention;

FIG. 4 illustrates a management system of data according to an embodiment of the present invention;

FIG. 5 is a flowchart for describing an example of processing procedures executed by a client device according to an embodiment of the present invention;

FIG. 6 illustrates a display example of a data operation screen;

FIG. 7 illustrates a display example of an item application screen;

FIG. 8 is a flowchart for describing an example of processing procedures executed by a data management server according to an embodiment of the present invention;

FIG. 9 illustrates examples of records of the application destination data item and the data item of a higher level of the application destination data item; and

FIG. 10 illustrates a configuration example of a specification configuration storage unit.

### DESCRIPTION OF EMBODIMENTS

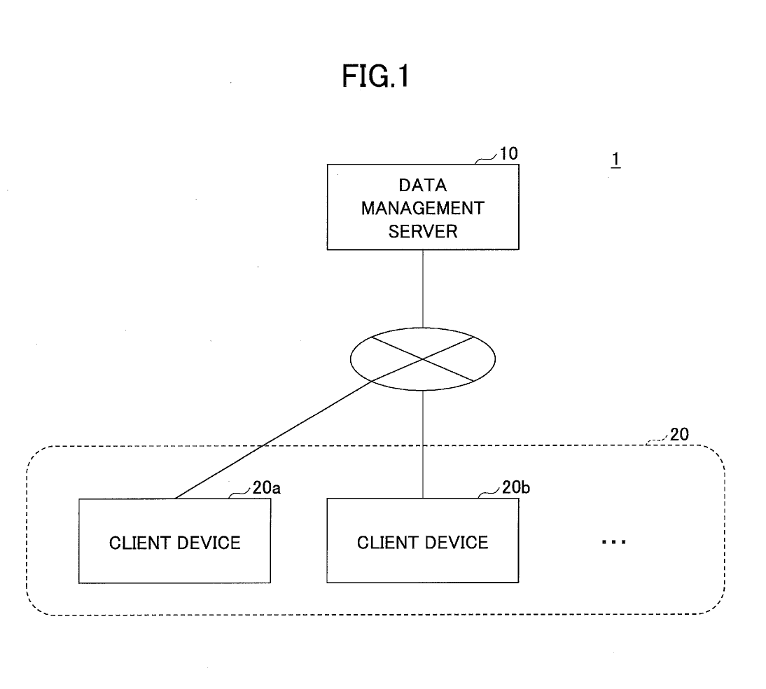

Preferred embodiments of the present invention will be explained with reference to accompanying drawings. FIG. 1 illustrates a configuration example of a data management system according to an embodiment of the present invention. In a data management system 1 illustrated in FIG. 1, a data management server 10 and at least one client device 20 are connected to each other via a network such as LAN (Local Area Network) or the Internet such that communication is possible.

The data management server 10 is a computer for managing data. A plurality of computers may constitute the data management server 10. For example, the deliverable created by a development process of a product such as electronic components of an automobile, is the data that is the management target. The deliverable may be, for example, document data, drawing data, or image data. However, the data that is the management target need not be limited to a particular type of data.

The client device 20 is a computer used for operating on the data managed by the data management server 10. A PC (Personal Computer), a tablet terminal, a smartphone, or a feature phone may be used as the client device 20.

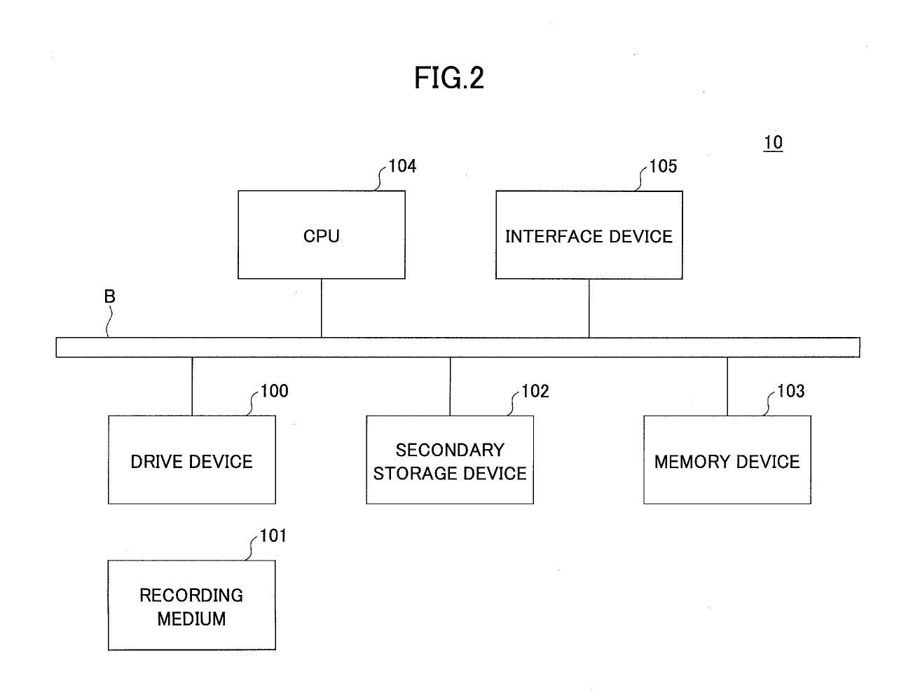

FIG. 2 illustrates an example of a hardware configuration of the data management server 10 according to an embodiment of the present invention. The data management server 10 illustrated in FIG. 2 includes a drive device 100, a secondary storage device 102, a memory device 103, a CPU 104, and an interface device 105, which are connected to each other via a bus B.

Programs for realizing processes at the data management server 10 are provided by a recording medium 101. When the recording medium 101 storing a program is set in the drive device 100, the program is installed in the secondary storage device 102 from the recording medium 101 via the drive device 100. However, a program need not be installed from the recording medium 101; a program may be downloaded from another computer via the network. The secondary storage device 102 stores the installed programs as well as files and data that are needed.

The memory device 103 reads a program from the secondary storage device 102 and stores the program, when an instruction to activate the program is given. The CPU 104 executes functions relevant to the data management server 10 according to programs stored in the memory device 103. The interface device 105 is used as an interface for connecting to the network.

Note that examples of the recording medium 101 are portable recording media such as a CD-ROM, a DVD disk, and a USB memory. Furthermore, examples of the secondary storage device 102 are HDD (Hard Disk Drive) and a flash memory. Both the recording medium 101 and the secondary storage device 102 correspond to a computer-readable recording medium.

Note that the data management server 10 may be a computer system including a plurality of computers. Furthermore, the client device 20 may also have hardware as illustrated in FIG. 2. Furthermore, the client device 20 may include an input device for receiving input from a user and a display device for displaying information to the user.

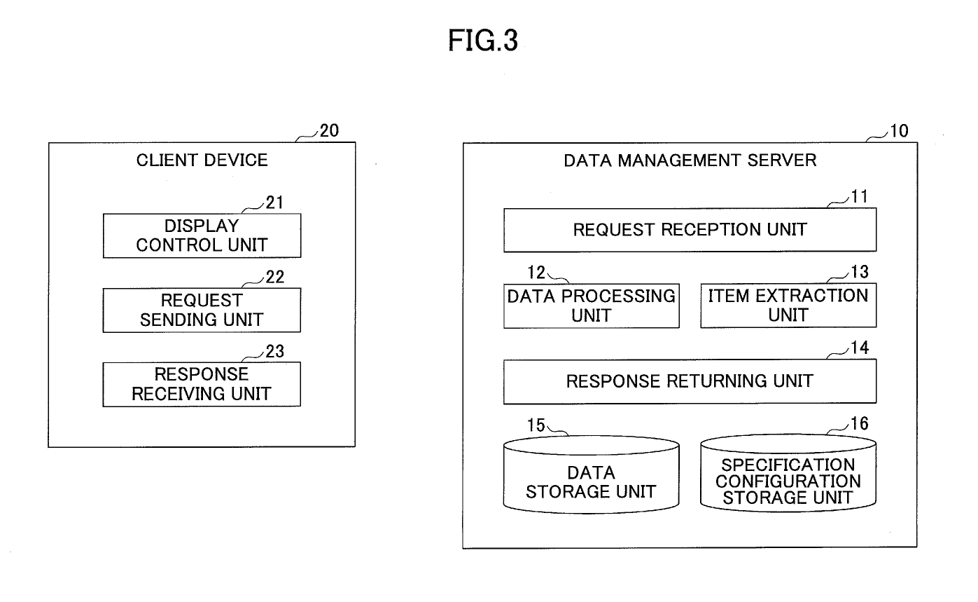

FIG. 3 illustrates an example of a functional configuration of the data management system 1 according to the present embodiment. In FIG. 3, the data management server 10 includes a request reception unit 11, a data processing unit 12, an item extraction unit 13, and a response returning unit 14. These units are realized by processes that the CPU 104 is caused to execute by one or more programs installed in the data management server 10. Furthermore, the data management server 10 includes a data storage unit 15 and a specification configuration storage unit 16. These storage units may be realized by using the secondary storage device 102 or storage devices connected to the data management server 10 via the network.

The request reception unit 11 receives a request from the client device 20. The data processing unit 12 executes a process in accordance with an operation request for data received by the request reception unit 11, on the data stored in the data storage unit 15. The specification configuration storage unit 16 stores information indicating the items constituting ISO26262, which is an example of an ISO (International Organization for Standardization) specification defining development processes of products. Items constituting ISO26262 are, for example, a chapter, a clause, and a section. In ISO26262, the item corresponding to a chapter is referred to as a part. ISO26262 includes ten parts. The part is further segmentalized, and includes items corresponding clauses and sections. That is to say, the items have a hierarchal structure (parent and child relationship). The specification configuration storage unit 16 stores the items such that the hierarchal structure may be identified. In the following, in the present embodiment, an “item” refers to an item constituting ISO26262.

The item extraction unit 13 extracts a candidate of an item to be associated with a certain data item from the specification configuration storage unit 16, when a request to present a candidate of an item to be associated with a certain data item is received by the request reception unit 11. That is to say, it is possible to apply, to the data stored in the data storage unit 15, an attribute indicating the association with an item.

The response returning unit 14 returns, to the client device 20, execution results of process performed by the data processing unit 12 and the item extraction unit 13.

The client device 20 includes a display control unit 21, a request sending unit 22, and a response receiving unit 23. The display control unit 21 displays, on a display device, a screen for receiving an instruction to operate on data that is the management target. The request sending unit 22 sends, to the data management server 10, an operation request according to the operation request input via the screen displayed by the display control unit 21. The response receiving unit 23 receives a response returned from the data management server 10, according to the operation request sent by the request sending unit 22. The information included in the response is displayed by the display control unit 21.

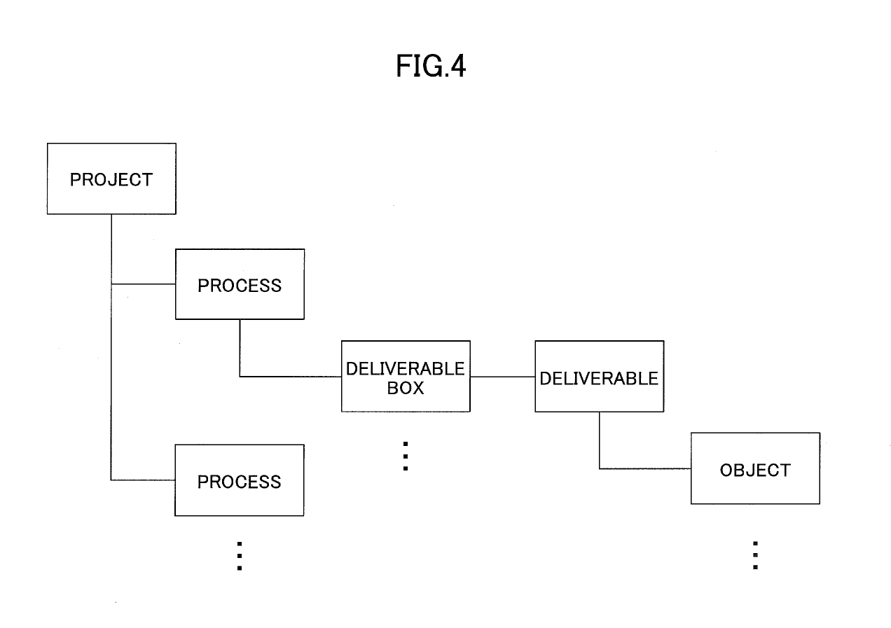

Next, a description is given of the management system of data that is the management target, according to the present embodiment. FIG. 4 illustrates a management system of data according to the present embodiment.

In FIG. 4, a project is a concept corresponding to a single product that is the development target. One or more processes belong to the project. A process is a concept corresponding to each stage of the development process of the product. One or more deliverable boxes belong to each process. The deliverable box is a concept expressing a box for storing the deliverable. Therefore, a deliverable belongs to a deliverable box. In the present embodiment, one deliverable box is prepared for each deliverable. That is to say, one deliverable may be stored in each deliverable box. However, a plurality of deliverables may be stored in a single deliverable box.

As described above, in the present embodiment, the storage destination of the deliverable is expressed by using a hierarchal structure constituted by a project, processes, and deliverable boxes. This hierarchal structure is referred to as a parent and child relationship. Note that data expressing a project, a process, a deliverable box, and a deliverable, is managed as records of a database in the data storage unit 14. For example, when a RDB (Relational Database) is used, a project is managed as records of a table (hereinafter, “project table”) having a format for a project. A process is managed as records of a table (hereinafter, “process table”) having a format for a process. A deliverable box is managed as a record of a table (hereinafter, “deliverable box table”) having a format for a deliverable box. A deliverable is managed as a record of a table (hereinafter, “deliverable table”) having a format for a deliverable.

Furthermore, in FIG. 4, an object is indicated as data belonging to a lower layer of the deliverable. An object is an element of a deliverable, which is extracted from the deliverable, in response to a user's instruction. For example, when the deliverable is a requirement definition document, each requirement is extracted as one object. The data expressing an object is managed as a record of a database, similar to other data. Specifically, the object is managed as a record of a table (hereinafter, “object table”) having a format for an object.

In the present embodiment, “data” is a record of a project, a process, a deliverable box, a deliverable, and an object. Among these, the project, the process, and the deliverable box are data constituting the storage destination of the deliverable, and are thus expressed as a folder with respect to the user. That is to say, a project is expressed as a folder storing one or more processes. A process is expressed as a folder storing one or more deliverable boxes. A deliverable box is expressed as a folder storing a deliverable. Thus, in the present embodiment a “folder” is used as a term meaning the highest conception of a project, a process, and a deliverable box.

In the present embodiment, the concept of distinguishing a project, a process, a deliverable box, and an object is referred to as a data type.

The parent and child relationship of the project, the process, the deliverable box, etc., is defined in advance by, for example, an administrator. The developer of a product creates a deliverable corresponding to the deliverable box as the development process proceeds, and registers the deliverable in the deliverable box. Accordingly, it is possible to manage the deliverables, such that it is easily recognized that the deliverables needed for development are created without any omission.

Furthermore, as described above, to each data item, it is possible to apply the association with an item constituting ISO26262 as an attribute. Accordingly, the association relationships between the respective data items and items of ISO26262 are clarified, and it is easily indicated that the operation procedures are in compliance with ISO26262.

The operation of associating the data items with the items of ISO26262 is performed by, for example, an administrator. In the present embodiment, a description is given of an example where the data management server 10 and the client device 20 provide support to enhance the efficiency of the operation. Note that the operation of associating data item A with an item A is referred to as “applying item A to data item A” in the present embodiment.

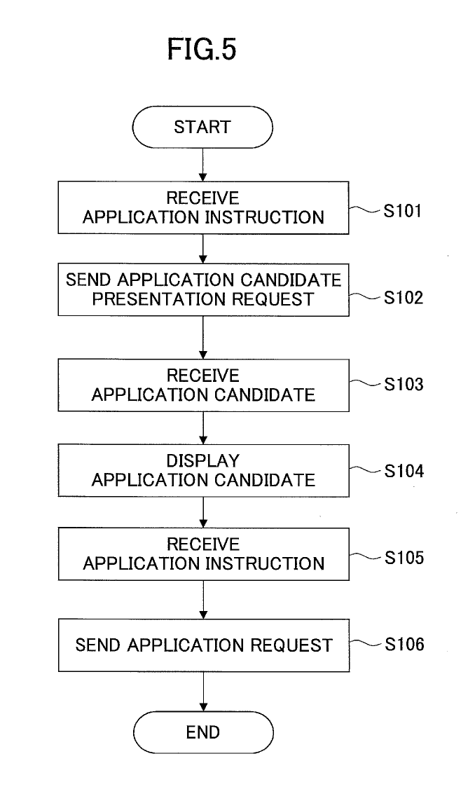

In the following, a description is given of processing procedures executed in the data management system 1. FIG. 5 is a flowchart for describing an example of processing procedures executed by the client device 20.

In step S101, the display control unit 21 receives an instruction to apply an item to a certain data item from the user via a data operation screen.

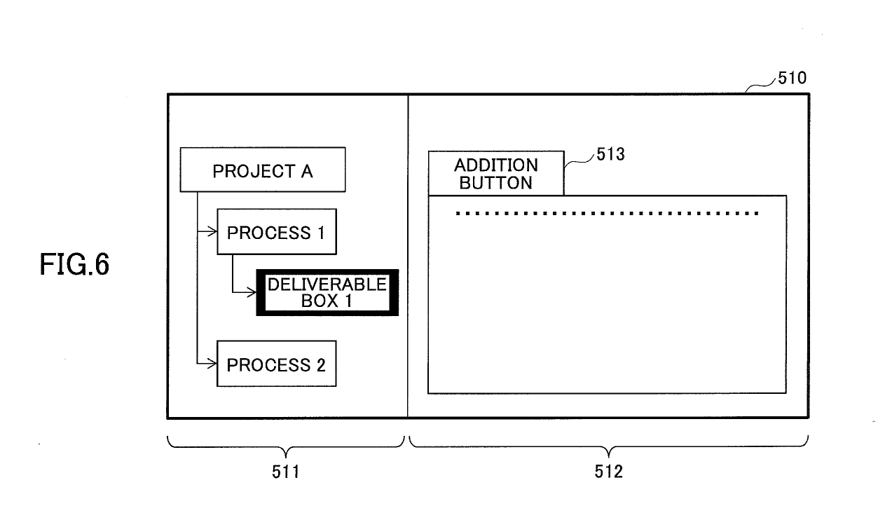

FIG. 6 illustrates a display example of a data operation screen. In FIG. 6, a data operation screen 510 includes a tree display area 511 and an information display area 512.

The tree display area 511 displays tree components indicating the parent and child relationship of the data items, assuming that each data item is a node. For example, the user double-clicks a certain node to expand the node. At the lower level of the expanded node, there is displayed a node of a data item belonging to the data item relevant to the expanded node. In FIG. 6, “project A” is expanded, and “process 1” and “process 2” are displayed at the lower level of the “project A”. Furthermore, “process 1” is expanded, and “deliverable box 1” is displayed at the lower level of “process 1”.

The information display area 512 displays, for example, information on a data item relevant to a node that has been selected in the tree display area 511. The information display area 512 includes an addition button 513. The addition button 513 is for receiving an instruction to apply an item of ISO26262 to the data item relevant to the node selected in the tree display area 511. That is to say, in step S101, as the user presses the addition button 513 in a state where one of the nodes is selected in the tree display area 511, an instruction to apply an item to the data item relevant to the selected node is received. In the following, the data item relevant to the selected node is referred to as an “application destination data item”. In the present embodiment, it is assumed that the information display area 512 is pressed when the “deliverable box 1” is selected. Note that data items belonging to other data types such as “project A” and “process 1” may be the application destination. Furthermore, data items relevant to deliverables and objects, which are not displayed in FIG. 6, may be the application destination of the item.

Next, the request sending unit 22 sends, to the data management server 10, an application candidate presentation request including the path name of the application destination data item (step S102). The path name of the application destination data item is identification information of the data item, including information indicating the parent and child relationship of the data item. For example, in the example of FIG. 6, the “project A/process 1/deliverable box 1” is the path name of the application destination data item. In response to this request, the item extraction unit 13 of the data management server 10 extracts, from the specification configuration storage unit 16, an item to be an application candidate for “deliverable box 1”. Details of the extraction process are described below.

Next, the response receiving unit 23 receives information indicating the application candidate extracted by the item extraction unit 13 (step S103). Next, the display control unit 21 causes the display device to display an item application screen including information indicating application candidates (step S104).

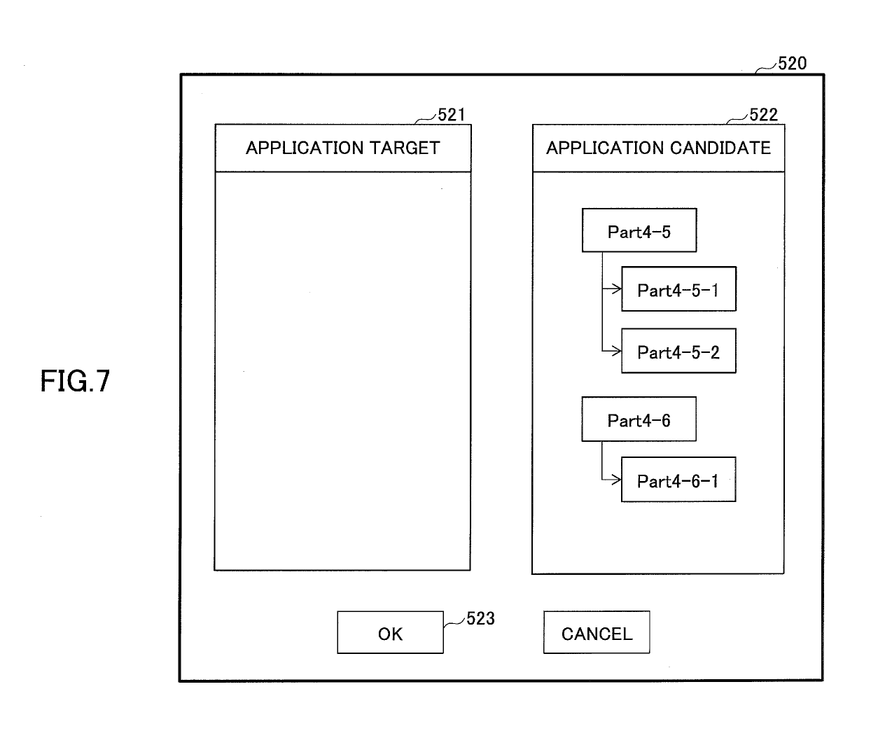

FIG. 7 illustrates a display example of an item application screen. In FIG. 7, an item application screen 520 includes an application target display area 521, an application candidate display area 522, and an OK button 523.

The application candidate display area 522 is an area that displays, as options that may be selected, item numbers of items that are application candidates returned from the data management server 10. The item number includes “Part” as the prefix and the identification number of the item following the prefix. The identification number of the item corresponding to a part is the number of the part. The identification number of the item corresponding to a clause has a format of “number of part-number of clause”. The identification number of the item corresponding to a section has a format of “number of part-number of clause-number of section”. That is to say, the identification number is formed by connecting the respective levels of the hierarchal structure of items by “-(hyphens)”. Therefore, an item number including the identification number is information indicating the parent and child relationship between the level of the item and another item. Note that the format of the identification information and the item number is not limited to the above.

In FIG. 7, each item number is displayed by a tree structure according to the hierarchal structure of the items. However, the item numbers may be displayed in a format of a list. In the case of a list format, the parent and child relationship between items may be expressed by displaying the item number of an item at a lower level of another item to be indented from the item number of the other item.

The application target display area 521 is an area displaying the item number of the item applied to the data item that is the application destination. For example, in the application candidate display area 522, when one of the item numbers is selected by double-clicking, the selected item number may be displayed in the application target display area 521. Furthermore, when an item number in the application target display area 521 is double-clicked, the double-clicked item number may be erased from the application target display area 521. The selection and the release of selection of the application target may be performed by other operations.

When the OK button 523 is pressed in a state where one or more item numbers are displayed in the application target display area 521 (step S105), the request sending unit 22 sends an application request including the item number to the data management server 10 (step S106).

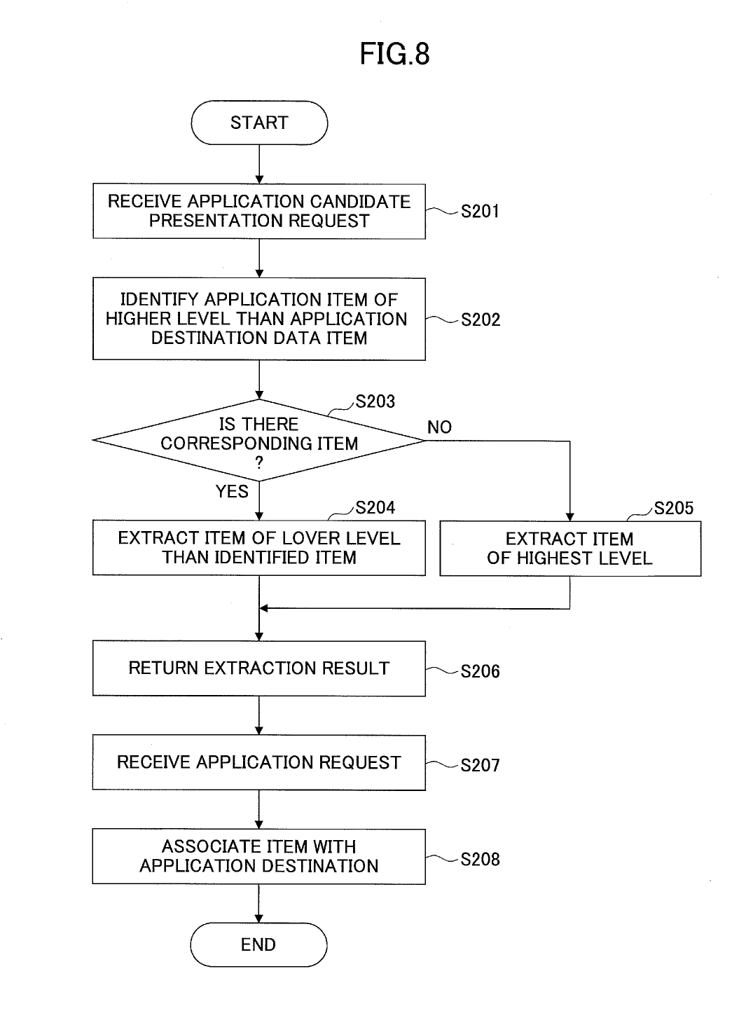

Next, a description is given of processing procedures executed by the data management server 10. FIG. 8 is a flowchart for describing an example of processing procedures executed by the data management server 10.

In step S201, the request reception unit 11 receives the application candidate presentation request sent in step S102. Next, the item extraction unit 13 identifies the item number applied to the data item of a higher level of the application destination data item based on a path name of the application destination data item, included in the application candidate presentation request (step S202). The item number applied to the data item of a higher level of the application destination data item, may be identified by referring to the record of the application destination data item and the record of the data item of a higher level of the application destination data item.

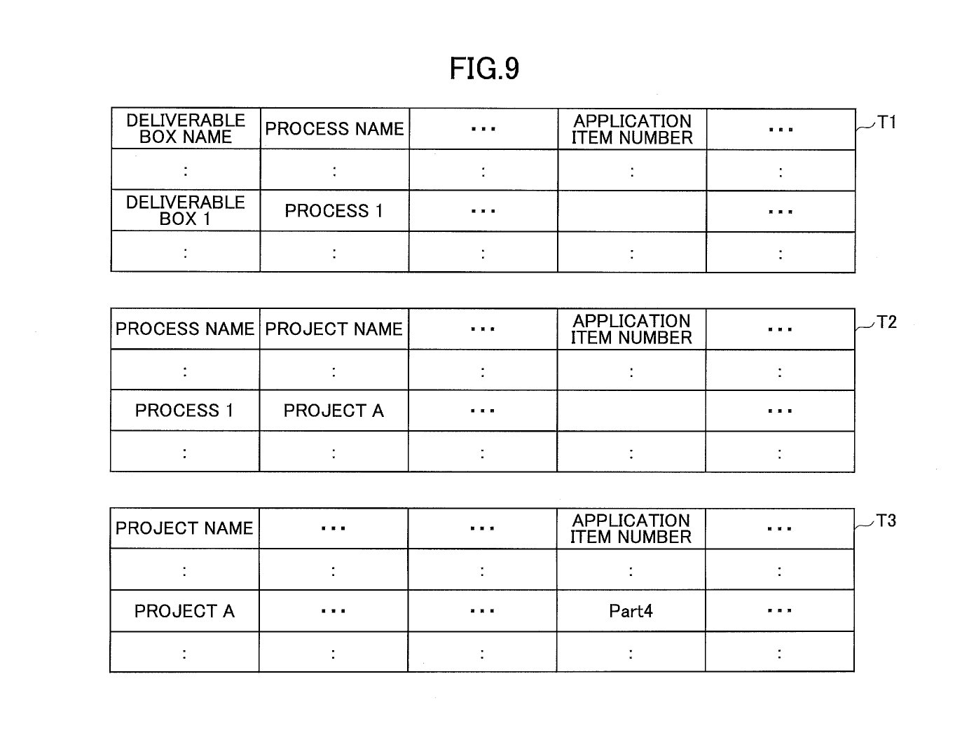

FIG. 9 illustrates examples of records of the application destination data item and the data item of a higher level of the application destination data item. FIG. 9 illustrates examples of a deliverable box table T1, a process table T2, and a project table T3.

The record of the deliverable box table T1 stores the data of a deliverable box. The record includes the deliverable box name, the process name, and various attributes relevant to the deliverable box. The process name is the name of the process to which the deliverable box belongs. The deliverable box table T1 indicates that the “deliverable box 1” belongs to “process 1”.

The record of the process table T2 stores data of a process. The record includes the process name, the project name, and various attributes relevant to the process. The project name is the name of the project to which the process belongs. The process table T2 indicates that the “process 1” belongs to “project A”.

The record of the project table T3 stores data of the project. The record includes the project and various attributes relevant to the project.

As clearly seen from the tables, each data item includes an application item number, as one of the attributes. The application item number is an item number applied to the data. That is to say, in each table, it is possible to save the association between the data and an item number.

For example, when the path name of the application destination data item is “project A/process 1/deliverable box 1”, the data of the higher level of the application destination data item is “process 1” and “project A”. Note that the data of the higher level may be identified based on the path name of the application destination data item, or may be identified based on the record of the application destination data item. In the latter case, “process 1” is identified based on the process name of the record of “deliverable box 1” of the deliverable table T1. Furthermore, “project A” is identified based on the project name of the record of “process 1” of the process table T2.

In step S202, item numbers are applied in the data of the higher level of the application destination data item, and an item number, which is applied to the data that is closest to the application destination data item in the parent and child relationship of data, is identified. That is to say, the item extraction unit 13 tracks back the parent and child relationship of data, starting from the application destination data item, to the data in which a value is stored as the application item number. As a result, when there is data of a higher level in which a value is stored as the application item number (YES in step S203), the item extraction unit 13 extracts, from the specification configuration storage unit 16, an item number of an item of a lower level than the item relevant to the application item number of the data (step S204).

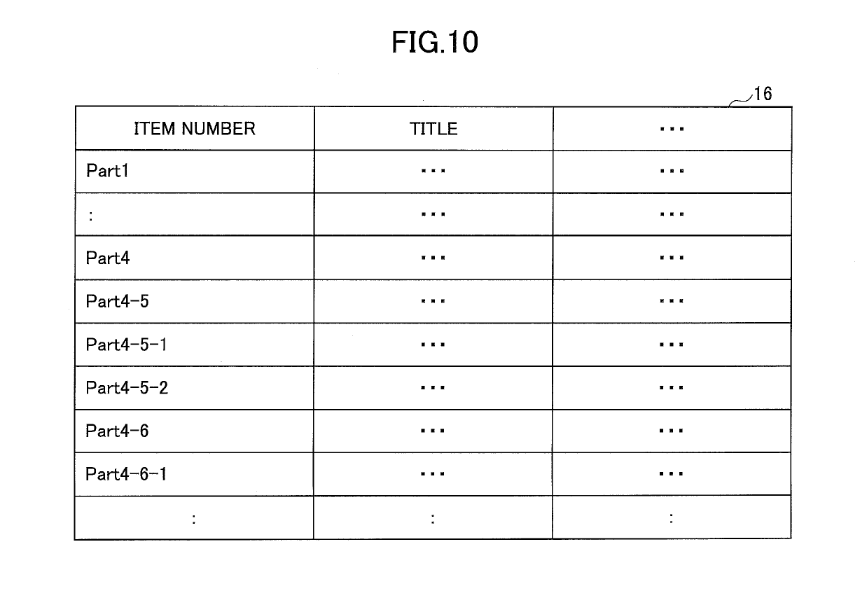

FIG. 10 illustrates a configuration example of the specification configuration storage unit 16. In FIG. 10, the specification configuration storage unit 16 stores an item number and a title for each item constituting ISO26262. A title is the title or index for a part, a clause, a section, etc.

For example, when the application destination data item is “project A/process 1/deliverable box 1”, in FIG. 9, an application item number is not stored for “process 1”, but an application item number “Part 4” is stored for “project A”. Therefore, in step S204, an item whose front part matches “Part 4” and which includes one or more “-(hyphens)”, is extracted as an item of a lower level of “Part 4”, from the specification configuration storage unit 16. That is to say, an item number of an item corresponding to a clause or a section belonging to “Part 4”, is extracted. In the example of FIG. 10, “Part4-5”, “Part4-5-1”, “Part4-5-2”, “Part4-6”, and “Part4-6-1” are the extraction results. Note that the extraction targets may be limited items that directly belong to “Part 4”. That is to say, an item number whose front part matches “Part 4” and which includes one “-(hyphen)” may be extracted in step S204. In this case, the extraction results are “Part4-5” and “Part4-6”.

Note that in the present embodiment, the hierarchal structure of items is identified by item numbers; however, for example, each record of the specification configuration storage unit 16 may store information for identifying the hierarchal structure. This information may be, for example, an item number of an item of one higher level in the hierarchal structure.

Meanwhile, in step S202, when there is no data of a higher level in which a value is stored as the application item number (NO in step S203), the item extraction unit 13 extracts an item number of an item of the highest level, from the specification configuration storage unit 16 (step S205). In the present embodiment, an item of the highest level is an item corresponding to a part (Part). Therefore, in step S205, an item number that does not include any “-(hyphens)” is extracted.

The item numbers extracted in step S204 or S205, are the item numbers of items that are application candidates with respect to the application destination data item.

After step S204 or S205, the response returning unit 14 returns the extracted item numbers to the client device 20 that is the transmission source of the application candidate presentation request (step S206). That is to say, the item numbers are output as options for applying to the application destination data item. Note that together with the extracted item numbers, information stored in the specification configuration storage unit 16 may be returned in association with the extracted item numbers.

Based on the item numbers, the application candidate display area 522 of the item application screen 520 illustrated in FIG. 7 is displayed. Note that the hierarchal structure between item numbers may be identified based on the respective item numbers.

Next, in step S207, the request reception unit 11 receives an application request sent in step S106. The application request includes the item number displayed in the application target display area 521, which is double-clicked in the application candidate display area 522 of the item application screen 520.

Next, the data processing unit 12 stores the item number included in the application request, in the application item number of the record of the application destination data item relevant to the path name included in the application candidate presentation request received in step S201 (step S208). That is to say, the item number is associated with the application destination data item. In the present embodiment, the item number is stored in the “application item number” of the record of the “deliverable box 1” of the deliverable table T1 of FIG. 9.

Note that information indicating whether the process according to the application request is successful, may be returned to the client device 20 as a response to the application request.

Note that assuming that an item is applied to the deliverable registered at a lower level than the “deliverable box 1”, an item at a lower level than an item applied to the “deliverable box 1” is displayed as an option in the application candidate display area 522 of the item application screen 520.

As described above, according to the present embodiment, when applying an attribute of one of the folders in a folder group storing data items that are development deliverables having a hierarchal structure, at least one of the plurality of items constituting ISO26262 is output as an option. Furthermore, an item selected from the options is associated with one of the folders. That is to say, the user may associate a folder with an item by selecting one of the output options. Therefore, the operation of associating the storage destination of data with an item constituting ISO26262, is increased in efficiency.

Furthermore, according to the present embodiment, when a certain item is associated with data (folder) of a higher level, an item that is at a lower level than the certain item is output as an option. That is to say, the options are refined. As a result, the desired items are easy to find from among the options, and the operation of associating the storage destination of data with an item constituting ISO26262, is further increased in efficiency.

Note that the present embodiment is applicable to ISO specifications other than ISO26262.

Note that in the present embodiment, the data management server 10 is an example of a data management device and a data management system. The item extraction unit 13 and the response returning unit 14 are examples of output units. The data processing unit 12 is an example of a control unit. The specification configuration storage unit 16 is an example of a storage unit.

The present invention is not limited to the specific embodiments described herein, and variations and modifications may be made without departing from the scope of the present invention.

According to an aspect of the embodiments, a management method, a management device, and a management system are provided, which are capable of enhancing the efficiency in the operation of associating the storage destination of data with an item constituting the ISO specification.

The present invention is not limited to the specific embodiments described herein, and variations and modifications may be made without departing from the scope of the present invention. Furthermore, all of or some of the elements in the above embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing a data management program that causes a computer to execute a process, the computer being configured to store data, which is a development deliverable of a product, in one of folders included in a storage folder group having a hierarchal structure, the process comprising:
referring to a storage unit storing a plurality of items constituting an ISO (International Organization for Standardization) specification defining a development process of the product;
outputting one or more items as options among the plurality of items constituting the ISO specification defining the development process of the product, when applying an attribute to the one of the folders included in the storage folder group; and
implementing control to store the attribute corresponding to a selected item among the one or more items that have been output in association with the one of the folders.

2. The non-transitory computer-readable recording medium according to claim 1, further comprising:
storing, by the storage unit, a hierarchal structure of the plurality of items constituting the ISO specification defining the development process of the product, wherein
the outputting includes outputting, as the options, the one or more items that are defined to be at a lower level than a particular item among the plurality of items according to the hierarchal structure of the plurality of items stored by the storage unit, when the particular item is already associated with a folder at a higher level than the one of the folders to which the attribute is to be applied.

3. A data management method executed by a computer configured to store data that is a development deliverable of a product, in one of folders included in a storage folder group having a hierarchal structure, the data management method comprising:
referring to a storage unit storing a plurality of items constituting an ISO (International Organization for Standardization) specification defining a development process of the product;
outputting one or more items as options among the plurality of items constituting the ISO specification defining the development process of the product, when applying an attribute to the one of the folders included in the storage folder group; and
implementing control to store the attribute corresponding to a selected item among the one or more items that have been output in association with the one of the folders.

4. The data management method according to claim 3, further comprising:
storing, by the storage unit, a hierarchal structure of the plurality of items constituting the ISO specification defining the development process of the product, wherein
the outputting includes outputting, as the options, the one or more items that are defined to be at a lower level than a particular item among the plurality of items according to the hierarchal structure of the plurality of items stored by the storage unit, when the particular item is already associated with a folder at a higher level than the one of the folders to which the attribute is to be applied.

5. A data management device configured to store data that is a development deliverable of a product, in one of folders included in a storage folder group having a hierarchal structure, the data management device comprising:
a processor configured to execute a process including
referring to a storage unit storing a plurality of items constituting an ISO (International Organization for Standardization) specification defining a development process of the product;
outputting one or more items as options among the plurality of items constituting the ISO specification defining the development process of the product, when applying an attribute to the one of the folders included in the storage folder group; and
implementing control to store the attribute corresponding to a selected item among the one or more items that have been output in association with the one of the folders.

6. The data management device according to claim 5, wherein the process further includes
storing, by the storage unit, a hierarchal structure of the plurality of items constituting the ISO specification defining the development process of the product, wherein
the outputting includes outputting, as the options, the one or more items that are defined to be at a lower level than a particular item among the plurality of items according to the hierarchal structure of the plurality of items stored by the storage unit, when the particular item is already associated with a folder at a higher level than the one of the folders to which the attribute is to be applied.

7. A data management system configured to store data that is a development deliverable of a product, in one of folders included in a storage folder group having a hierarchal structure, the data management system comprising:
a processor configured to execute a process including
referring to a storage unit storing a plurality of items constituting an ISO (International Organization for Standardization) specification defining a development process of the product;
outputting one or more items as options among the plurality of items constituting the ISO specification defining the development process of the product, when applying an attribute to the one of the folders included in the storage folder group; and
implementing control to store the attribute corresponding to a selected item among the one or more items that have been output in association with the one of the folders.

8. The data management system according to claim 7, wherein the process further includes
storing, by the storage unit, a hierarchal structure of the plurality of items constituting the ISO specification defining the development process of the product, wherein
the outputting includes outputting, as the options, the one or more items that are defined to be at a lower level than a particular item among the plurality of items according to the hierarchal structure of the plurality of items stored by the storage unit, when the particular item is already associated with a folder at a higher level than the one of the folders to which the attribute is to be applied.
